(19) United States
(12) Patent Application Publication
(10) Pub. No.: US 2022/0188167 A1
(43) Pub. Date: Jun. 16, 2022

(54) SYSTEM AND METHOD TO ADAPT MEMORY USAGE OF CONTAINERIZED WORKSPACES

(71) Applicant: DELL PRODUCTS, LP, Round Rock, TX (US)

(72) Inventors: Vivek Viswanathan Iyer, Austin, TX (US); Michael S. Gatson, Austin, TX (US)

(21) Appl. No.: 17/120,775

(22) Filed: Dec. 14, 2020

(51) Int. Cl. G06F 9/50; G06F 9/455; G06F 9/4401; G06N 20/00

(52) U.S. Cl. CPC G06F 9/5044; G06F 9/5016; G06F 2009/45595; G06F 9/4418; G06N 20/00; G06F 9/45558

(57) ABSTRACT

An information handling system includes a hardware resource, a container handler, and a container manager. The container manager classifies containers into classifications based upon allocations of the hardware resource, categorizes the containers based upon a usage of the containers and the classification, and directs the container handler to instantiate the containers on the information handling system. The manager receives a request to instantiate a new container on the information handling system, and classifies and categorizes the new container. When a sum of the first and second allocations does not exceed a total amount of the hardware resource, the manager directs the container handler to instantiate the second container on the information handling system. When the sum exceeds the total amount, the manager determines whether or not the first usage is greater than the second usage, and directs the handler to instantiate the new container on the network system when the first usage is greater than the second usage.

### FIELD OF THE DISCLOSURE

This disclosure generally relates to information handling systems, and more particularly relates to adapting memory usage of containerized workspaces in an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may include a hardware resource, a container handler, and a container manager. The manager may classify containers into classifications based upon allocations of the hardware resource, categorize the containers based upon a usage of the containers and the classification, and direct the container handler to instantiate the containers on the information handling system. The manager may receive a request to instantiate a new container on the information handling system, and classify and categorizes the new container. When a sum of the first and second allocations does not exceed a total amount of the hardware resource, the manager may direct the container handler to instantiate the second container on the information handling system. When the sum exceeds the total amount, the manager may determine whether or not the first usage is greater than the second usage, and direct the handler to instantiate the new container on the network system when the first usage is greater than the second usage.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of a workspace according to an embodiment of the current disclosure;

FIG. 2 is a flowchart illustrating a method for adapting memory usage of containerized workspaces according to an embodiment of the current disclosure; and

FIG. 3 is a block diagram illustrating a generalized information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

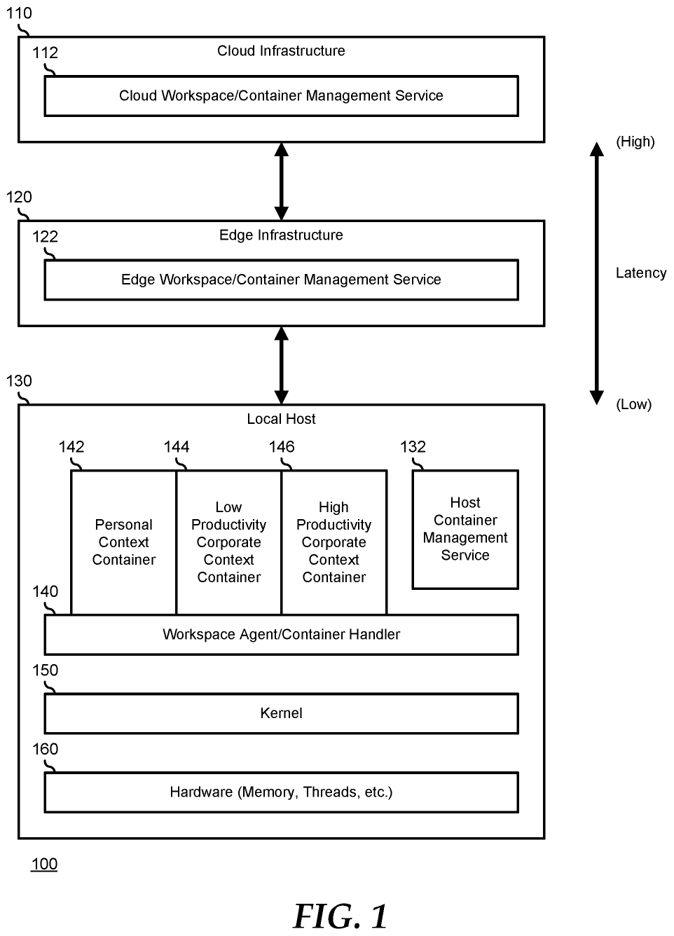

FIG. 1 illustrates a workspace 100, including cloud-based infrastructure 110 (hereinafter “cloud 110”), edge-based infrastructure 120 (hereinafter “edge 120”), and a local host information handling system 130. Cloud 110 represents processing and storage resources that are available to information handling system 130, but that are located at a relatively remote location to the information handling system, such as at a large datacenter or centralized corporate network infrastructure. In particular, cloud 110 represents a functionally limitless processing and storage capacity that is available to information handling system 130, but that may be available with a high latency, both in terms of network transport round-trip times, and processing times at the cloud infrastructure. It will be understood that cloud 110 may, in actual fact, be a limited resource for information handling system 130, based upon service agreements, processing and data storage caps, and the like, but, to the extent that a user of the information handling system can negotiate additional resources from the cloud, the cloud can be understood to not be resource constrained under normal circumstances. Cloud 110 includes a cloud workspace/container management service 112 (hereinafter “cloud management service 112”), described further below.

Edge 120 represents processing resources that are available to information handling system 130, but that are located more proximately to the information handling system. For example, edge 120 may represent more localized shared resources for data processing and storage, such as vehicle-to-everything (V2X) computing and communications, localized automation environments, augmented reality (AR) or virtual reality (VR) environments, connected home or office environments, distributed computing (e.g., fog computing) environments, and the like. Here, edge 120 represents more limited processing and storage capacity that is available to information handling system 130, Edge 120 includes an edge workspace/container management service 122 (hereinafter “cloud management service 122”), described further below.

Information handling system 130 represents the local data processing and storage resources that are available on a computing device that is local to a particular user, such as a computer or workstation, a laptop computer, a tablet device, a smart phone device, or a local node of edge 120. Information handling system 130 includes a host workspace/container management service 132 (hereinafter “host management service 132”), described further below, a workspace agent/container handler 140, a operating system kernel 150, and local hardware resources 160. Hardware resources 160 represent the components and elements of information handling system 130 that are utilized to perform processing tasks on the information handling system. As such, hardware resources 160 may include processors, memory devices, data storage devices, input/output (I/O) devices, and the like, and may be understood to include other services, routines, utilities, and the like that are operated on the hardware resources to facilitate the operation of the hardware resources, such as a system BIOS/UEFI, firmware, and the like. Kernel 150 represents an operating system instantiated on information handling system 130, and may include various Windows, OS-X, Linux, or other operating systems as needed or desired.

Kernel 150 instantiates handler 140 to manage the instantiation of a personal context container 142, a low productivity corporate context container 144, and a high productivity corporate context container 146. Containers 142, 144, and 146 represent segmented workload environments instantiated on information handling system 130 that are isolated from each other in terms of interaction between the data and processing needs of the containers, and that utilize the resources of kernel 150 and hardware resources 160. In particular, containers 142, 144, and 146 may be distinguished from virtual machines in that a virtual machine typically emulates a complete processing environment, that is, a virtual information handling system, and all of the hardware, software, firmware, BIOS/UEFI resources of the virtual machine are represented by the virtual machine. In contrast, containers 142, 144, and 146 each operate within the host environment of information handling system 130. Here, various memory regions, processor threads, virtual I/O functions, and the like, may be allocated to each of containers 142, 144, and 146, and such memory regions, processor threads, virtual I/O functions, and the like are functionally isolated from the other containers, but the containers do not typically emulate a complete information handling system, as is the case with a virtual machine. In this regard, handler 140 operates to receive container requests from a user of information handling system 130, from edge 120, or from cloud 110, determines the resource allocation needed to instantiate the associated containers, allocates the resources from hardware resources 160, launches the associated containers, and, when the use of a particular container is completed, to shut down the particular container and deallocate the resources associated with the particular container. An example of handler 140 may include Docker, Linux-VServer, Kata Containers, Bottlerocket, Kubernetes, or another proprietary or open source container program, as needed or desired. Note that handler 140 may also represent a workload agent that is associated with a virtual desktop environment, where workloads are instantiated on information handling system 130 by a remote virtual desktop manager. The details of operating containers is known in the art, and will not be further described herein, except as needed to illustrate the current embodiments. Further, it will be understood that handler 140 may also represent web-based delivery mechanism, such as a Progressive Web Application (PWA) of the like.

Containers 142, 144, and 146 may be completely instantiated on information handling system 130, or may be instantiated in parts on the information handling system and also on one or more of cloud 110 and edge 120. In particular, the processing loads and memory needs of a particular container may be completely allocated from hardware resources 160, or the processing loads and memory needs of the container may be split, utilizing some of hardware resources 160, and some resources of cloud 110 or edge 120. For example, personal context container 142 may represent a user's personal (i.e., non-work related) processing needs, such as accessing private e-mail and text resources, web browsing, personal office productivity applications, and the like. Here, container 142 may represent a set of minimum features needed to provide the personal processing needs, and such a container may be fully resident on information handling system 130. In another example, low productivity corporate context container 144 may represent a user's work-related processing needs for day-to-day functions, similar to the functions provided by personal context container 142, but with added security, isolation, and access controls to permit the user to access a corporate network. Here, low productivity corporate context container 144 may include user interface features that are instantiated on information handling system 130, and various sessions or container adjuncts that are instantiated on edge 120 or on cloud 110. Finally, high productivity corporate context container 146 may represent a user's work-related processing needs for more compute intensive functions, such as CAD/CAE work, simulations, and the like. Here, the necessary processing resources may not be available on a small scale device like information handling system 130, but may need the processing resources of a data center, such as might be available in cloud 110.

It has been understood by the inventors of the present invention that containerization represents an increasingly attractive option for managing remote (i.e., work-from-home) computing resources. In particular, a corporate IT department can concentrate on providing various containers for instantiating different work contexts. Then, as long as a user has compatible hardware, the work contexts can be managed and maintained by the corporate IT department, without having to worry about compatibility across multiple types of users' systems. However, as the use of containers increases, and particularly as the number of containers instantiated on an information handling system at any given time increases, the flexibility of the individual information handling system becomes constrained because more and more of the hardware resources of the information handling system are being allocated to the various containers. It will be understood that containers are instantiated with a particular pre-defined configuration, for example specifying a minimum or maximum amount of memory, a minimum or maximum number of threads, a minimum or maximum amount of storage, a minimum or maximum amount of I/O bandwidth, and the like. When a container is instantiated on an information handling system without sufficient available memory resources, the container may be starved for resources due to excessive memory swaps, causing the container or the information handling system to crash.

As an example, consider the following four containers which might be expected to be instantiated simultaneously on a particular user's information handling system, and their associated memory requirements:

Container 1: Personal (Real-time, persistent)
Baseline docker=50 MB
Chrome (8 tabs)=1 GB
Personal UWP app (whatsapp)=400 MB
Personal UWP app (other)=500 MB
Corporate IT Base Load=500 MB
Teams=500 MB
Total=˜3 GB

Container 2: Casual Productivity (Real-time, Less Frequent)
Baseline docker=50 MB
Corporate IT Base Load=500 MB
Outlook=500 MB
Powerpoint (2 files)=500 MB
Teams=500 MB
Total=˜2 GB

Container 3: Casual Productivity (Real-time, Less Frequent)
Baseline docker=50 MB
Corporate IT Base Load=500 MB
Excel (2 files)=100 MB
Visio (3 files)=200 MB
Powerpoint=500 MB
Teams=500 MB
Total=˜2 GB

Container 4: High Productivity (Less Real-time, Less Frequent)
Baseline docker=50 MB
Corporate IT Base Load=500 MB
Powerpoint (5 files tied to autocad work)=1 GB
Autodesk CFD=8 GB (16 recommended for larger models)
Total=˜10 GB
   Further consider a typical use case where a user employs a laptop computer with 16 GB RAM. Here, it can readily be seen that the instantiation of all four containers simultaneously would result in over subscribing of the memory resources of the laptop computer.

Host management service 132 operates to manage the instantiation, location, and resource allocation of containers 142, 144, and 146 on information handling system 130. In particular, host management service 132 operates to 1) classify the containers that are instantiated or requested to be instantiated on information handling system 130, 2) categorize each container in terms of one of various predefined operating modes based upon the classification information and the current operating state of the information handling system, and 3) take actions on the containers based upon the current operating state and changes in the operating state of the information handling system.

In classifying containers 142, 144, and 146, host management service 132 determines the usage needs of each container, relative to the availability of hardware resources 160. For example, host management service 132 can determine whether each container demands real-time operation or can be run in the background, determine a minimum and maximum number of processing threads needed by each container, determine a minimum and maximum amount of system memory needed by each container, determine a minimum and maximum amount of I/O bandwidth needed by each container, determining a tolerance for latency in the operation of each container, and the like, as needed or desired.

Having classified containers 142, 144, and 146, host management service 132 categorizes each container as being operable in one of the various predefined operating modes. Table 1, below provides examples of the various predefined operating modes. It will be understood that other modes may be provided, as needed or required.

TABLE 1
Exemplary Container Operating Modes

| Mode | Description | Actions |
|---|---|---|
| 1 | Real-Time, Run Often and | Always run locally at optimal |
| | Needed All the Time | config. |
| 2 | Real-Time when running but | Hibernate when not actively used, |
| | OK with startup time, run | but keep on client. Reduce |
| | occasionally | memory footprint when hibernated |
| 3 | Need Real-Time when | Fetch on demand from edge/cloud, |
| | running, run infrequently | start on client, and run. Save and |
| | | stop container when done |
| 4 | Run from edge/cloud always | Run as web app/PWA from local |
| | container to minimize client | |
| | memory resources | |
| 5 | Run from cloud when user is | Location 1: Run as web app/PWA |
| | one location, run locally on | from local container to minimize |
| | demand when user is | client memory resources |
| | another location (Hybrid of | Location 2: Fetch on demand from |
| | modes based on context) | edge/cloud, start on client, and run. |
| | | Save and stop container when done. |

After categorizing containers 142, 144, and 146 into one of the various modes, host management service 132 operates to direct handler 140 to instantiate the containers as provided by actions associated with each mode. Exemplary actions associated with each mode are provided in Table 1, above. For example, a particular container can be ascribed as a Mode 1 container, needing constant real-time operation. Here, host management service 132 directs handler 140 to instantiate that container on information handling system 130 and to maintain that container as an always-on container on the information handling system. Here, a user may direct handler 140 to shut down the container or to hibernate the container to edge 120 or to cloud 110, as needed or desired, or, for example, where the container includes a set task, the container can shut itself down when the task is complete. In such cases, handler 140 reports that the container has been shut down to host management service 132, indicating that the resources associated with the container are now available to be allocated to other containers as needed.

Another container can be ascribed as a Mode 2 container, needing occasional real-time operation. Here, host management service 132 directs handler 140 to instantiate that container on information handling system 130, to maintain that container on the information handling system while in use, and to hibernate the container when not in use. Here, when the container is hibernated, handler 140 reports that the container is hibernated to host management service 132, indicating that a portion of the resources associated with the container are now available to be allocated to other containers as needed, and that only a small portion of the resources needed to resume state from hibernation need to be maintained.

Yet another container can be ascribed as a Mode 3 container, needing infrequent real-time operation. Here, host management service 132 directs handler 140 to instantiate that that container on information handling system 130, to maintain that container on the information handling system while in use, and to shut down and save the container when not in use. As above, handler 140 reports the container status to host management service 132 to deallocate the resources from the container when it is shut down.

Yet another container can be ascribed as a Mode 4 container that does not necessitate real-time operation at all. Here, host management service 132 directs handler 140 to not instantiate that that container on information handling system 130, but to run that container out of edge 120 or cloud 110, as needed or desired. Mode 5 may be considered as a location-based hybrid of Modes 3 and 4, where a Mode 5 container is managed similarly to a Mode 3 container in a first location, and is managed similarly to a Mode 4 container in a second location. For example, in a first location where network connectivity is not assured, running this container on information handling system 130 may be prudent, while in a second location with greater internet connectivity, running this container from edge 120 or cloud 110 may be sufficient.

In a particular embodiment, host management service 132 operates to categorize containers 142, 144, and 146 into particular modes based upon a rules engine that evaluates the classification of each container to determine, for example, a numeric value for each container, and then prioritizes the containers based upon the numeric value. For example, in a simple case, each container can be evaluated to determine a percentage of real-time operation, and can prioritize the containers with higher percentages of real-time operation over the containers with lower percentages. In another example, a higher priority can be ascribed to a container in proportion to the minimum memory requirement, such that higher memory usage containers are granted a higher priority, or in inverse proportion to the minimum memory requirement, such that lower memory usage containers are granted the higher priority. Other characterization metrics can be utilized, such as latency, I/O requirements, thread requirements, and the like, as needed or desired.

In a particular embodiment, host management service 132 operates to manage containers 142, 144, and 146 based upon a rules engine that defines the actions to take in response to changes in the operating conditions on information handling system 130 and the categorized modes of the containers. For example, where a higher priority container experiences an increase in system memory demand, host management service 132 can operate to direct handler 140 to hibernate one or more lower priority containers to accommodate the increased system memory demand.

In a particular embodiment, one or more containers are instantiated with predetermined modes ascribed to them. For example, where workspace 100 represents a corporate processing environment, containers associated with work-related tasks can be ascribed modes that ensure that they retain priority over containers associated with personal-related tasks, in spite of considerations of the categorization information or percentage of real-time operation.

In a particular embodiment, host management service 132 provides a machine learning algorithm to the management of containers 142, 144, and 146, such that hardware resources 160 remain utilized to the maximum extent possible, based upon current and past usages of the containers.

Cloud management service 112 and edge management service 122 are similar to host management service 132. In particular, cloud management service 112 and edge management service 122 operate to classify, categorize, and manage containers 142, 144, and 146 as described above. Here, however, cloud management service 112 and edge management service 122 are configured to communicate with information handling system 130 to determine the various capacities of the information handling system, and the current operating status of the information handling system in order to perform the various classifying, categorizing, and managing of the containers. Here, workspace 100 is provided with maximum flexibility to manage containers on a wide variety of information handling system types, as needed or desired. This my be desirable in an IT environment where the IT organization within a company manages the container content, but does not manage the actual information handling systems. Here, even without direct control of the information handling system hardware, cloud management service 112 and edge management service 122 can manage and optimize the performance of the containers on the various types of information handling systems without having to actually manage the information handling systems.

It will be understood that the teachings, while described in the context of a user's needs on an information handling system, the functions and features of a host management service, as described above, may be applicable to other processing environments with limited resources and an ability to balance resource demand with proximity (i.e., latency) of access to the resources, as described above. For example, in a V2X environment, containers or workloads associated with vehicle critical operation and safety may be placed into a mode associated with maintaining the containers or workloads resident on the vehicle, containers or workloads associated with traffic awareness and terrain avoidance may be placed into a mode associated with offloading the containers or workloads to an edge network, and containers or workloads associated with passenger entertainment or navigation may be placed into a mode associated with offloading the containers or workloads to a cloud.

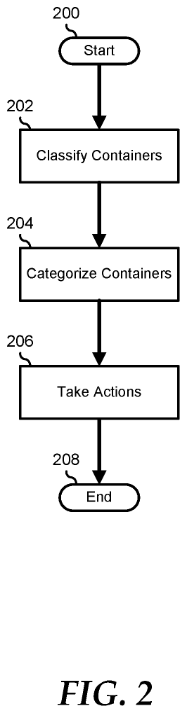

FIG. 2 illustrates a method to adapt memory usage of containerized workspaces, starting at block 200. A container management service in a workspace classifies the containers that are instantiated or requested to be instantiated on an information handling system in block 202. The container management service categorizes each container in terms of one of various predefined operating modes based upon the classification information and the current operating state of the information handling system in block 204. The container management service directs a container handler of the information handling system to change the operations of the containers based upon the current operating state and changes in the operating state of the information handling system in block 206, and the method ends in block 208.

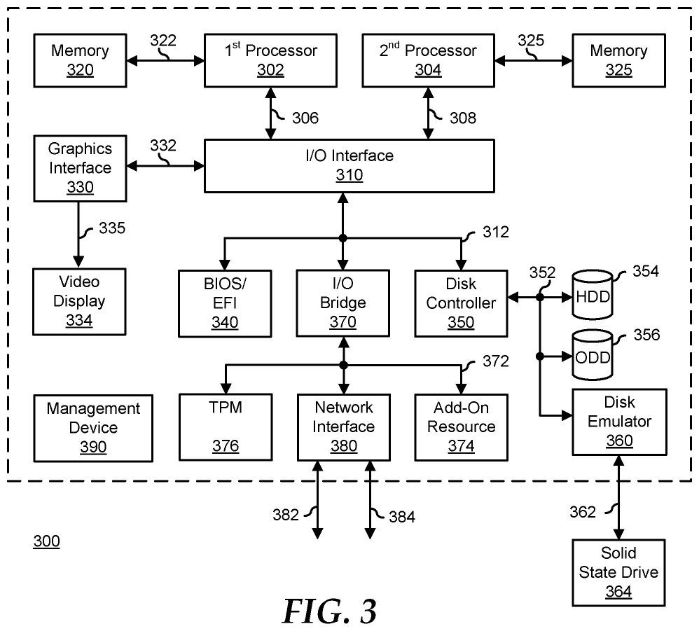

FIG. 3 illustrates a generalized embodiment of an information handling system 300. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below, and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 362, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 362, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332, and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 1394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312, or can be a different type of interface. As such, I/O bridge 370 extends the capacity of I/O channel 312 when peripheral interface 372 and the I/O channel are of the same type, and the I/O bridge translates information from a format suitable to the I/O channel to a format suitable to the peripheral channel 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (00B) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300. Management device 390 can operate off of a separate power plane from the components of the host environment so that the management device receives power to manage information handling system 300 when the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system, comprising:
a hardware resource;
a container handler configured to instantiate containers on the information handling system and to instantiate containers on a network system coupled to the information handling system; and
a container manager configured to:
classify a first container into a first classification based upon a first allocation of the hardware resource;
categorize the first container based upon a first usage of the first container and the first classification;
direct the container handler to instantiate the first container on the information handling system;
receive a request to instantiate a second container on the information handling system;
classify the second container into a second classification based upon a second allocation of the hardware resource;
categorize the second container based upon a second usage of the second container and the second classification;
when a sum of the first allocation and the second allocation does not exceed a total amount of the hardware resource, direct the container handler to instantiate the second container on the information handling system; and
when the sum exceeds the total amount, to:
determine whether the first usage is greater than the second usage; and
direct the container handler to instantiate the second container on the network system when the first usage is greater than the second usage.

2. The information handling system of claim 1, wherein, when the second usage is greater than the first usage, the container manager is further configured to:
direct the container handler to hibernate the first container to the network system; and
instantiate the second container on the information handling system.

3. The information handling system of claim 1, wherein the container manager is further configured to:
receive a request to instantiate a third container on the information handling system;
classify the third container into a third classification based upon a third allocation of the hardware resource;
categorize the third container based upon a third usage of the third container and the third classification; and
when the third usage is less than both the first usage and the second usage, direct the container handler to instantiate the third container on the network system.

4. The information handling system of claim 3, wherein the container manager is further configured to:
when the third usage is greater than both the first usage and the second usage, direct the container handler to instantiate the third container on the information handling system.

5. The information handling system of claim 4, wherein, when the third usage is greater than both the first usage and the second usage, the container manager is further configured to:
direct the container handler to hibernate the second container to the network system when a sum of the first allocation, the second allocation, and the third allocation exceeds the total amount and the first usage is greater than the second usage.

6. The information handling system of claim 1, wherein the first usage is determined based upon a request to instantiate the first container on the information handling system.

7. The information handling system of claim 1, wherein the first usage is determined based upon a historical usage pattern for the first container on the information handling system.

8. The information handling system of claim 7, wherein the historical usage pattern is determined based upon a machine learning algorithm.

9. The information handling system of claim 1, wherein the hardware resource includes one of a system memory space, a processor thread, and an input/output bandwidth.

10. A method, comprising:
classifying, by a container manager of an information handling system, a first container into a first classification based upon a first allocation of a hardware resource of the information handling system;
categorizing the first container based upon a first usage of the first container and the first classification;
directing a container handler of the information handling system to instantiate the first container on the information handling system, wherein the container manager is configured to instantiate containers on the information handling system and to instantiate containers on a network system coupled to the information handling system;
receiving a request to instantiate a second container on the information handling system;
classifying the second container into a second classification based upon a second allocation of the hardware resource;
categorizing the second container based upon a second usage of the second container and the second classification;
when a sum of the first allocation and the second allocation does not exceed a total amount of the hardware resource, directing the container handler to instantiate the second container on the information handling system; and
when the sum exceeds the total amount:
determining whether the first usage is greater than the second usage; and
directing the container handler to instantiate the second container on the network system when the first usage is greater than the second usage.

11. The method of claim 10, wherein, when the second usage is greater than the first usage, the method further comprises:
directing the container handler to hibernate the first container to the network system; and
instantiate the second container on the information handling system.

12. The method of claim 10, further comprising:
receiving a request to instantiate a third container on the information handling system;
classifying the third container into a third classification based upon a third allocation of the hardware resource;
categorizing the third container based upon a third usage of the third container and the third classification; and
when the third usage is less than both the first usage and the second usage, directing the container handler to instantiate the third container on the network system.

13. The method of claim 12, further comprising:
when the third usage is greater than both the first usage and the second usage, directing the container handler to instantiate the third container on the information handling system.

14. The method of claim 13, wherein, when the third usage is greater than both the first usage and the second usage, the method further comprises:
directing the container handler to hibernate the second container to the network system when a sum of the first allocation, the second allocation, and the third allocation exceeds the total amount and the first usage is greater than the second usage.

15. The method of claim 10, wherein the first usage is determined based upon a request to instantiate the first container on the information handling system.

16. The method of claim 10, wherein the first usage is determined based upon a historical usage pattern for the first container on the information handling system.

17. The method of claim 16, wherein the historical usage pattern is determined based upon a machine learning algorithm.

18. The method of claim 10, wherein the hardware resource includes one of a system memory space, a processor thread, and an input/output bandwidth.

19. An information handling system, comprising:
a memory device;
a container handler configured to instantiate containers on the information handling system and to instantiate containers on a network system coupled to the information handling system; and
a container manager configured to:
classify a first container into a first classification based upon a first allocation of the memory device;
categorize the first container based upon a first usage of the first container and the first classification;
direct the container handler to instantiate the first container on the information handling system;
receive a request to instantiate a second container on the information handling system;
classify the second container into a second classification based upon a second allocation of the memory device;
categorize the second container based upon a second usage of the second container and the second classification;
when a sum of the first allocation and the second allocation does not exceed a total amount of the memory device, direct the container handler to instantiate the second container on the information handling system;
when the sum exceeds the total amount, to:
determine whether the first usage is greater than the second usage; and
direct the container handler to instantiate the second container on the network system when the first usage is greater than the second usage; and
when the second usage is greater than the first usage:
direct the container handler to hibernate the first container to the network system; and
instantiate the second container on the information handling system.

20. The information handling system of claim 19, wherein the container manager is further configured to:
receive a request to instantiate a third container on the information handling system;
classify the third container into a third classification based upon a third allocation of the memory device;
categorize the third container based upon a third usage of the third container and the third classification; and
when the third usage is less than both the first usage and the second usage, direct the container handler to instantiate the third container on the network system.
